(19) United States
(12) Patent Application Publication
(10) Pub. No.: US 2024/0160913 A1
(43) Pub. Date: May 16, 2024

(54) ALLOCATING RESPONSIBILITY FOR AUTONOMOUS AND SEMI-AUTONOMOUS MACHINE INTERACTIONS AND APPLICATIONS

(71) Applicant: NVIDIA Corporation, Santa Clara, CA (US)

(72) Inventors: Ryan Cosner, Altadena, CA (US); Yuxiao Chen, Newark, CA (US); Karen Yan Ming Leung, Los Altos, CA (US); Marco Pavone, Stanford, CA (US)

(21) Appl. No.: 18/051,114

(22) Filed: Oct. 31, 2022

(51) Int. Cl. G06N 3/08

(52) U.S. Cl. CPC G06N 3/08

(57) ABSTRACT

In various examples, learning responsibility allocations for machine interactions is described herein. Systems and methods are disclosed that train a neural network(s) to generate outputs indicating estimated levels of responsibilities associated with interactions between vehicles or machines and other objects (e.g., other vehicles, machines, pedestrians, animals, etc.). In some examples, the neural network(s) is trained using real-world data, such as data representing scenes depicting actual interactions between vehicles and objects and/or parameters (e.g., velocities, positions, directions, etc.) associated with the interactions. Then, in practice, a vehicle (e.g., an autonomous vehicle, a semi-autonomous vehicle, etc.) may use the neural network(s) to generate an output indicating a proposed or estimated level of responsibility associated with an interaction between the vehicle and an object. The vehicle may then use the output to determine one or more controls for the vehicle to use when navigating.

### BACKGROUND

Drivers have a duty to exercise reasonable care when interacting with other drivers on the road. For example, if a first driver in a first vehicle is following a second driver in a second vehicle, the first driver has a duty to exercise reasonable care by driving at a safe velocity and safe distance in order to avoid a collision with the second vehicle. Additionally, the second driver also has a duty to exercise reasonable care by not unnecessarily stopping and thus increasing the likelihood of causing a rearend collision. In some circumstances, one driver may need to exercise a greater amount of reasonable care than another driver. For instance, and using the example above, the first, trailing driver may need to exercise a greater amount of reasonable care to avoid the rearend collision with the second, leading driver since the first driver is able to take additional precautions for avoiding the collision. For instance, the first driver may maintain a safe distance from the second driver or drive at a velocity that allows the first driver to safely stop no matter what action is taken by the second driver (e.g., the second driver unnecessarily stops).

For autonomous and semi-autonomous vehicles, existing systems may model and/or estimate other driver's behaviors in order to exercise reasonable care. For instance, some systems model and/or estimate other driver's behaviors using worst-case assumptions, such as by assuming that the other drivers will actively attempt to collide with the autonomous and/or semi-autonomous vehicles. However, since other drivers will likely try avoiding collisions rather than actively seeking the collisions, such systems may cause the autonomous and/or semi-autonomous vehicles to behave overly cautiously—such as by making unnecessary maneuvers (e.g., changing directions from set paths, stopping, etc.) in attempts to avoid collisions that would not occur.

Some systems model and/or estimate other driver's behaviors using static assumptions. For example, a system of an autonomous and/or semi-autonomous vehicle may assume that all drivers located in front of the autonomous and/or semi-autonomous vehicle on a specific road will continue at a current velocity without changing driving directions. However, since drivers do tend to make unnecessary or unexpected maneuvers in certain circumstances, these static assumptions may not be adequate. For instance, and using the example above, if a driver in front of the autonomous and/or semi-autonomous vehicle makes an unnecessary and/or unexpected maneuver, such as suddenly stopping or changing lanes, the autonomous and/or semi-autonomous vehicle may have to quickly react in order to avoid a collision.

### SUMMARY

Embodiments of the present disclosure relate to learning responsibility allocations for machine interactions. Systems and methods are disclosed that train a neural network(s) to generate outputs indicating levels of responsibilities associated with interactions between vehicles or machines and other objects (e.g., other vehicles, machines, pedestrians, animals, etc.). In some examples, the neural network(s) is trained using real-world data, such as data representing scenes depicting actual interactions between vehicles or machines and other objects and/or parameters (e.g., velocities, positions, directions of travel, etc.) associated with the interactions. Then, in practice, a machine (e.g., an autonomous vehicle, a semi-autonomous vehicle, a robot, etc.) may use the neural network(s) to generate an output indicating a level of responsibility associated with an interaction between the machine and another object(s) within an environment. The machine may then use the output to determine one or more controls, such a velocity, an acceleration, a turning rate, and/or the like, for navigating through the environment. In some examples, the machine may perform such processes using temporal information in order to ensure safety for a given period of time in the future.

In contrast to conventional systems, such as those described above, the current systems, in some embodiments, determine levels of responsibility between vehicles or machines and other objects, where the levels of responsibility are then used to determine controls for navigating the machine. This process may provide improvements over conventional systems that operate using worst-case assumptions for objects within environments, which may cause vehicles to behave overly conservatively. For instance, the levels of responsibility may more accurately indicate the actual motion (e.g., driving behaviors) of the other objects, such that the machines do not make unnecessary or overly conservative maneuvers while still safely navigating the environment.

Additionally, this may provide improvements over conventional systems that use static assumptions for other objects, which may not fully account for unreasonable and/or unnecessary maneuvers that drivers make in some circumstances. For instance, since, in some embodiments, the levels of responsibility are determined using a neural network(s) that is trained using data representing real-world interactions between vehicles and objects, the neural network(s) may determine the levels of responsibility based on accounting for unreasonable and/or unnecessary maneuvers that drivers or other objects (e.g., whether autonomous, semi-autonomous, or non-autonomous) may make in some circumstances (e.g., the real-world interactions may include such circumstances). As such, the machines, when determining the controls using the levels of responsibility, may also account for the unreasonable and/or unnecessary maneuvers.

### BRIEF DESCRIPTION OF THE DRAWINGS

The present systems and methods for learning responsibility allocations for machine interactions are described in detail below with reference to the attached drawing figures, wherein:

FIG. 1 illustrates an example data flow diagram for a process of using responsibility allocations when navigating within an environment, in accordance with some embodiments of the present disclosure;

FIG. 2 illustrates an example of a scene that may be input into a neural network(s) that is trained to determine responsibility allocations, in accordance with some examples of the present disclosure;

FIGS. 3A-3B illustrate an example neural network(s) for processing data in order to determine responsibility allocations, in accordance with some embodiments of the present disclosure;

FIG. 4 illustrates an example of determining responsibility allocations between a vehicle and an object, in accordance with some examples of the present disclosure;

FIG. 5 is a data flow diagram illustrating a process for training a neural network(s) to determine responsibility allocations, in accordance with some embodiments of the present disclosure;

FIG. 6 is a flow diagram showing a method for using a responsibility allocation when navigating a vehicle within an environment, in accordance with some embodiments of the present disclosure;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

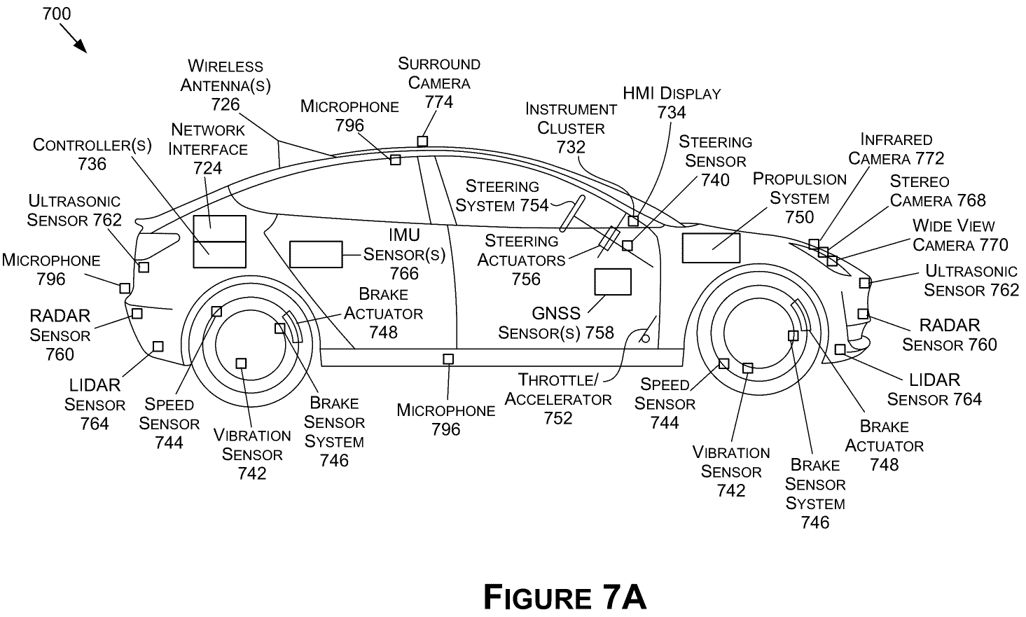

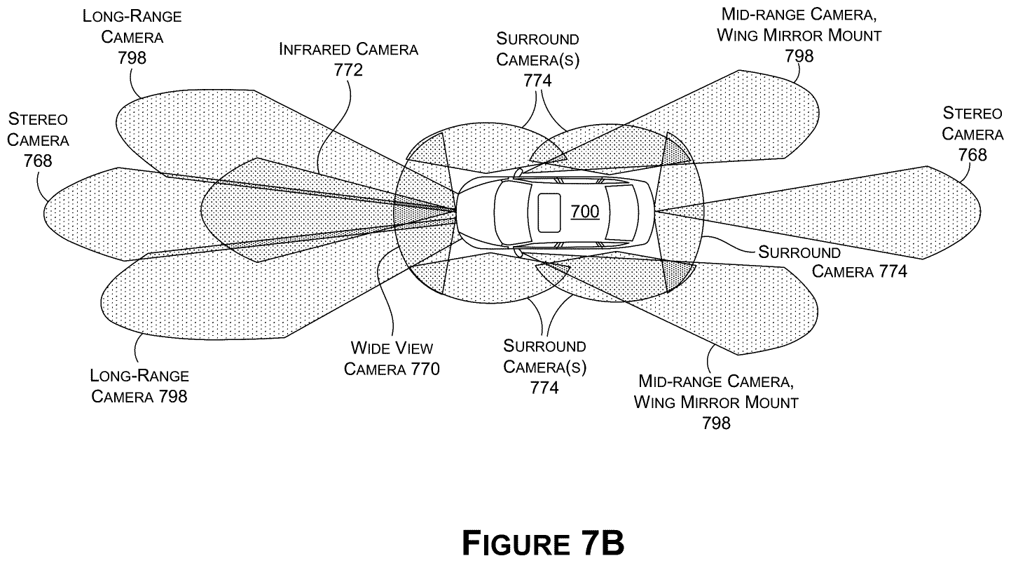

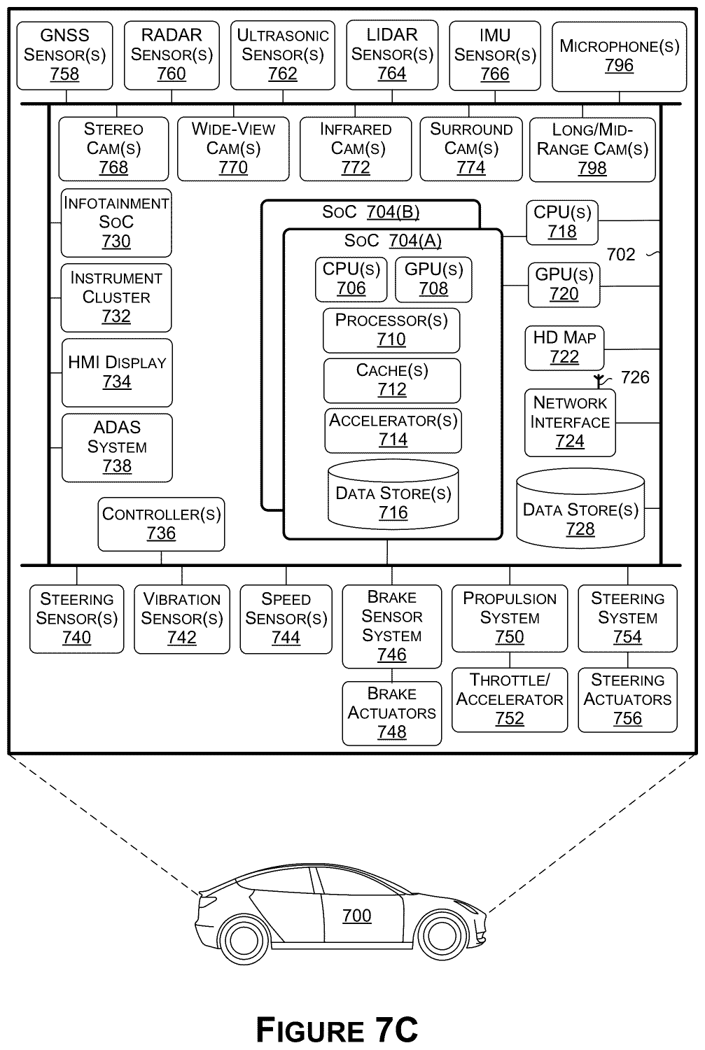

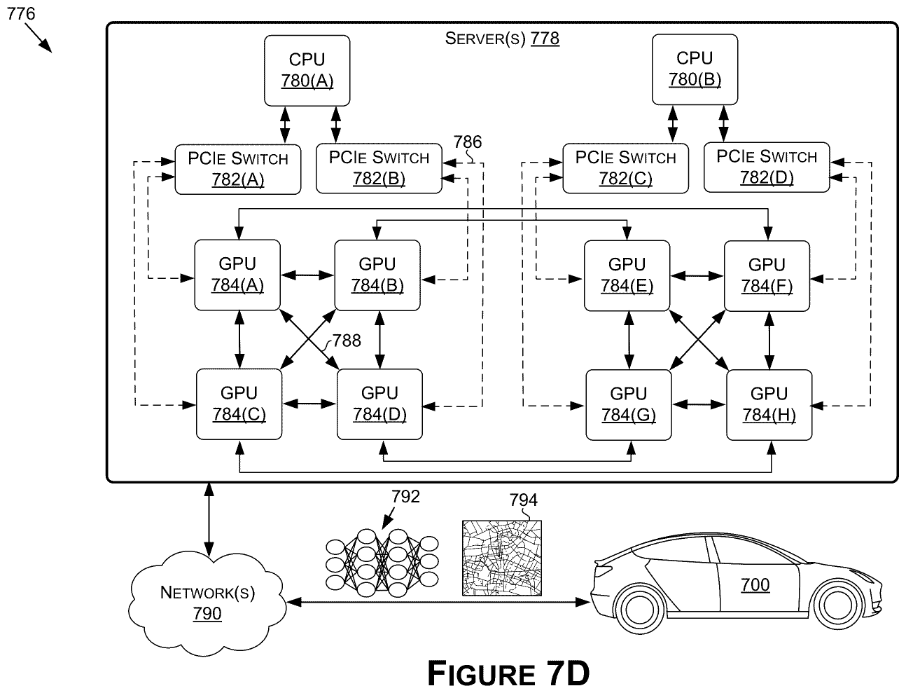

Systems and methods are disclosed related to learning responsibility allocations for machine interactions. Although the present disclosure may be described with respect to an example autonomous or semi-autonomous vehicle or machine 700 (alternatively referred to herein as “vehicle 700” or “ego-machine 700,” an example of which is described with respect to FIGS. 7A-7D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to autonomous and/or semi-autonomous machine navigation, this is not intended to be limiting, and the systems and methods described herein may be used in augmented reality, virtual reality, mixed reality, robotics, security and surveillance, autonomous or semi-autonomous machine applications, and/or any other technology spaces where responsibility allocation may be used.

For instance, a system(s) may train a neural network(s) to determine responsibility allocations between vehicles (and/or other machines) and objects (e.g., other vehicles, pedestrians, animals, machines, etc.) within environments. For example, and in a real-world environment, a responsibility to drive or operate safely and/or avoid a collision may be shared between a vehicle or other machine (e.g., a driver of the vehicle, a system of an autonomous and/or semi-autonomous vehicle, etc.) and an object(s) (e.g., a driver of another vehicle, a system of another autonomous and/or semi-autonomous vehicle, etc.). In some examples, the responsibility may be evenly shared, such that the vehicle or machine and the object may both be required to exercise an even amount of care to avoid the collision. For example, if the vehicle and the object (e.g., another vehicle) are navigating directly at one another, both the vehicle and the object may need to take maneuvers to avoid the collision, such as turning away from one another or stopping. In other examples, one of the vehicle or the object may have a greater amount of the responsibility, such that the vehicle or the object may be required to exercise a greater amount of care than the other to avoid the collision. For example, if the vehicle is following the object (e.g., another vehicle) on a road, the vehicle may need to take extra care to avoid the collision, such as navigating at a safe velocity and/or a safe distance that allows the vehicle to stop before colliding with the object if the object were to suddenly brake.

To train the neural network(s), the system(s) may use real-world data and/or simulation data representing actual demonstrations of vehicles and/or objects interacting. For example, and for a single demonstration, the data may represent at least (1) a scene (e.g., a top-down image) of the environment that depicts a vehicle, at least one object, and traffic features (e.g., a road(s), a traffic sign(s), a road marking(s), etc.) and (2) parameters associated with the vehicle and/or the object. As described herein, a parameter may include, but is not limited to, a position of the vehicle within the environment, an acceleration of the vehicle, a velocity of the vehicle, a direction of travel of the vehicle, a turning rate of the vehicle, a position of the object within the environment (which may be relative to the vehicle), an acceleration of the object, a velocity of the object, a turning rate of the object, a classification of the object, and/or any other parameter. As will be described in more detail herein, the system(s) may train the neural network(s) using this data along with one or more loss functions that are based on one or more constraints.

In some examples, the system(s) may then use the trained neural network(s) to perform one or more processes. For example, as a vehicle is navigating through an environment, the vehicle may generate sensor data representing or corresponding to the environment. The vehicle (and/or another system(s), such as a remote system(s) that communicates with the vehicle) may then use the sensor data to generate additional data, such as data representing a scene (e.g., a top-down image) of the environment and data representing one or more parameters associated with the vehicle and/or an object located within the environment. Additionally, the vehicle (and/or the other system(s)) may input the data into the neural network(s) that is trained to process the data and, based on the processing, output data representing or corresponding to a level of responsibility associated with the interaction between the vehicle and the object. In some examples, the level of responsibility may indicate that the vehicle and the object share an equal amount of the responsibility. In some examples, the level of responsibility may indicate that the vehicle shares a greater amount of the responsibility as compared to the object. Still, in some examples, the level of responsibility may indicate that the vehicle shares a lesser amount of the responsibility as compared to the object.

The vehicle may then use the data representing the level of responsibility to determine one or more controls for navigating within the environment. As described herein, a control may include, but is not limited to, an acceleration of the vehicle, a turning rate of the vehicle, a velocity of the vehicle, and/or any other control. For example, the vehicle may analyze one or more initial controls that the vehicle may take using the data representing the level of responsibility. In some examples, the vehicle analyzes the initial control(s) using a function, such as a Control Barrier Function (CBF), that includes inputs associated with the initial control(s) and the level of responsibility. Based on the analysis, the vehicle may determine whether the initial control(s) is safe to perform based on the level of responsibility. If the vehicle determines that the initial control(s) is safe to perform, then the vehicle may perform the initial control(s) within the environment. However, if the vehicle determines that the initial control(s) is unsafe to perform, then the vehicle may determine one or more new control(s) to perform, which are safe, based on the level of responsibility.

In some examples, the vehicle may perform these processes for one or more other objects (e.g., each object) within the environment. For example, the vehicle may determine a respective level of responsibility for one or more additional (e.g., each) vehicle and object pairs and then use those levels of responsibility to determine the control(s). Additionally, in some examples, the vehicle may perform these processes using one or more safety metrics, such as a distance metric, a velocity metric, and/or the like. For example, the vehicle may perform these processes using the distance metric that ensures that the vehicle remains at least a safe distance (e.g., a threshold distance) from the object while navigating.

In some examples, in addition to or alternatively from using the neural network(s) for navigating vehicles, the system(s) may use the neural network(s) to analyze situations that have already occurred. For instance, such as if a collision occurs between two vehicles, the system(s) may generate data representing the environment associated with the collision, such as data representing a scene(s) (e.g., a top-down image(s) of the environment) and one or more parameters associated with one or more of the vehicles. The system(s) may then input the data into the neural network(s) that is trained to output data indicating a level(s) of responsibility associated with the vehicles. For example, the neural network(s) may output data indicating first levels of responsibility associated with a first vehicle and second levels of responsibility associated with a second vehicle over a period of time before and/or during the collision. The system(s) may then use the levels of responsibility to determine which vehicle was the cause or contributed more to the collision. For example, the system(s) may determine that the vehicle that had the greatest level of responsibility was the largest contributor to the occurrence of the collision.

Although described herein as determining responsibility allocations and/or collision fault contributions, it should be noted that the responsibility allocations and fault contributions are estimated, and are not to be interpreted as conclusory. For example, although the system may predict that a vehicle has more responsibility than another vehicle, or that the vehicle is more at fault for a collision than another vehicle, this is not intended to be a factual or concrete answer or indictment of fault, but rather an informative tool or estimate of the responsibility allocation and/or fault contribution of various actors in an environment. Using this tool, the system of machine (e.g., for planning, control, obstacle avoidance, etc.) may be better informed and operate more effectively—e.g., without being overly conservative (e.g., by always assuming the worst) or not conservative enough (e.g., by not factoring in enough of the dynamic information about the environment).

The systems and methods described herein may be used by, without limitation, non-autonomous vehicles or machines, semi-autonomous vehicles or machines (e.g., in one or more adaptive driver assistance systems (ADAS)), autonomous vehicle or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

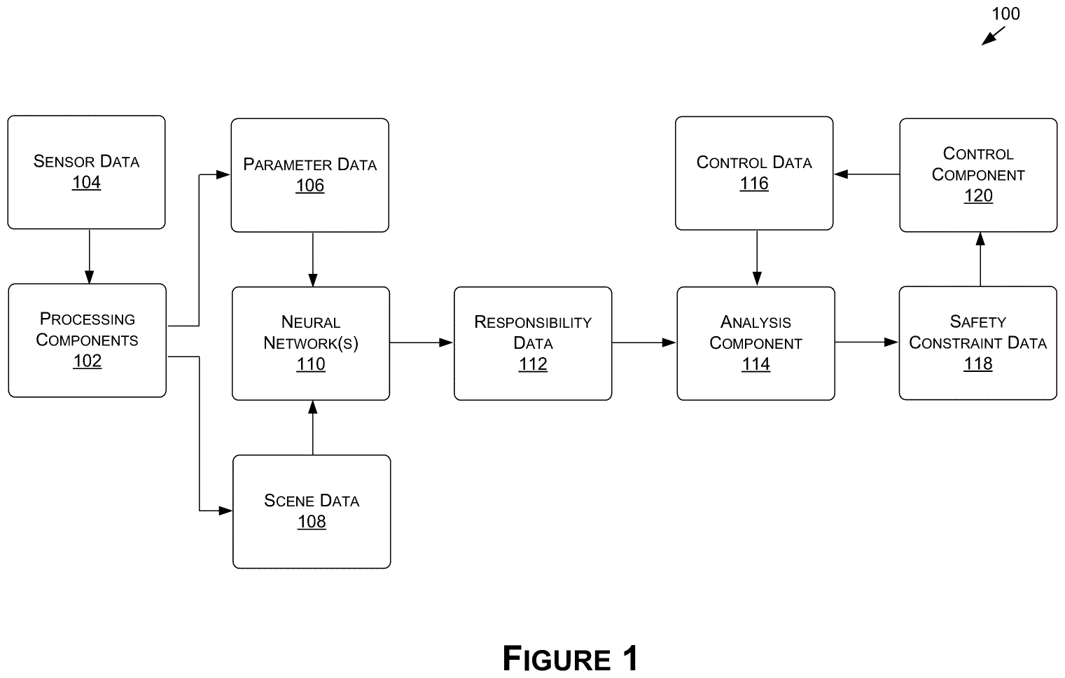

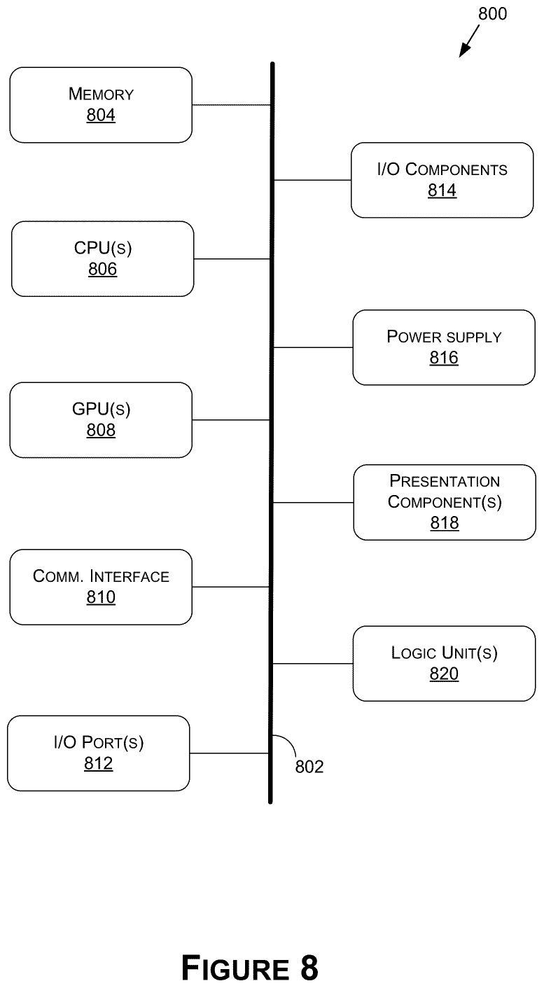

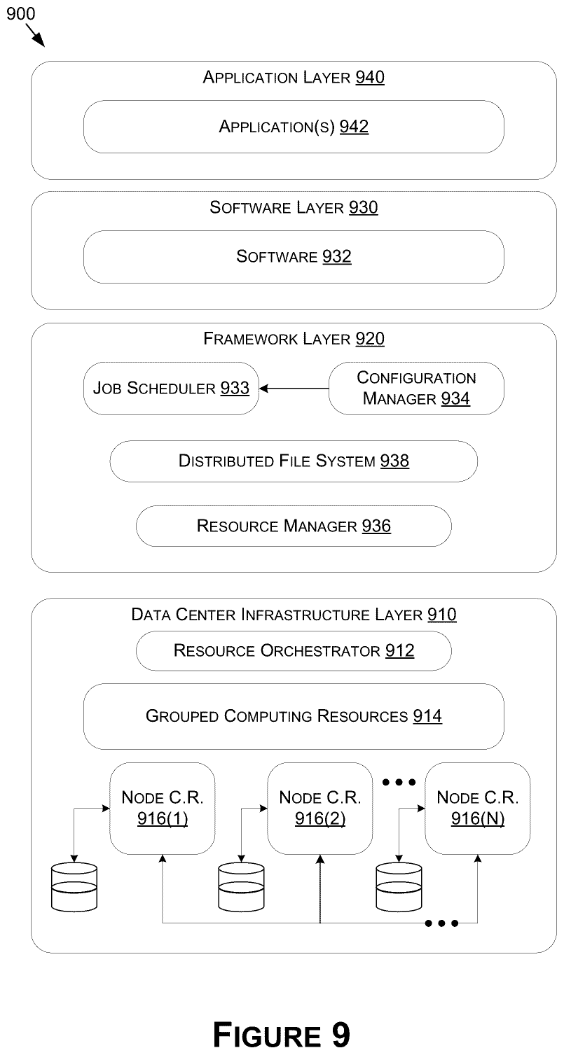

FIG. 1 illustrates an example data flow diagram for a process 100 of using responsibility allocations when navigating within an environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 700 of FIGS. 7A-7D, example computing device 800 of FIG. 8, and/or example data center 900 of FIG. 9.

The process 100 may include a processing component 102 that processes sensor data 104 generated using one or more sensors of a vehicle. For instance, the vehicle may use the one or more sensors, such as one or more image sensors (e.g., one or more cameras), one or more RADAR sensors, one or more LiDAR sensors, one or more inertial measurement unit sensors, one or more speed sensors, and/or the like, to generate the sensor data 104. In some examples, the sensor data 104 may represent and/or correspond to an environment in which the vehicle is navigating. As such, the sensor data 104 may represent and/or correspond to at least an object(s) (e.g., another vehicle(s), a machine(s), a pedestrian(s), an animal(s), a structure(s), etc.) within the environment, a traffic feature(s) (e.g., a road(s), a road marking(s), a traffic sign(s), etc.) within the environment, a map of the environment, and/or the like. The vehicle may then use the processing component 102 to process the sensor data 104. In some examples, the processing component 102 may include one or more systems of the vehicle such as, but not limited to, a perception system of the vehicle.

The process 100 may include the processing component 102 generating, based at least on processing the sensor data 104, parameter data 106 and scene data 108. For instance, the processing component 102 may be configured to generate the parameter data 106 representing one or more parameters associated with the vehicle and/or at least one object within the environment. For instance, and for a single object, the parameter data 106 may represent a position of the vehicle within the environment, an acceleration of the vehicle, a velocity of the vehicle, a direction of travel of the vehicle, a turning rate of the vehicle, a position of the object within the environment (which may be relative to the vehicle), an acceleration of the object, a velocity of the object, a turning rate of the object, a classification of the object, and/or any other parameter for the vehicle and/or the object.

The processing component 102 may further be configured to generate the scene data 108 representing a scene of the environment for which the vehicle is navigating. As described herein, the scene may indicate at least the position of the vehicle, the position of the object, and/or traffic features (e.g., a road(s), a traffic sign(s), a road marking(s), etc.) within the scene or environment. In some examples, the scene may be represented or depicted using a top-down (or birds eye view (BEV)) image or other sensor data representation of the environment.

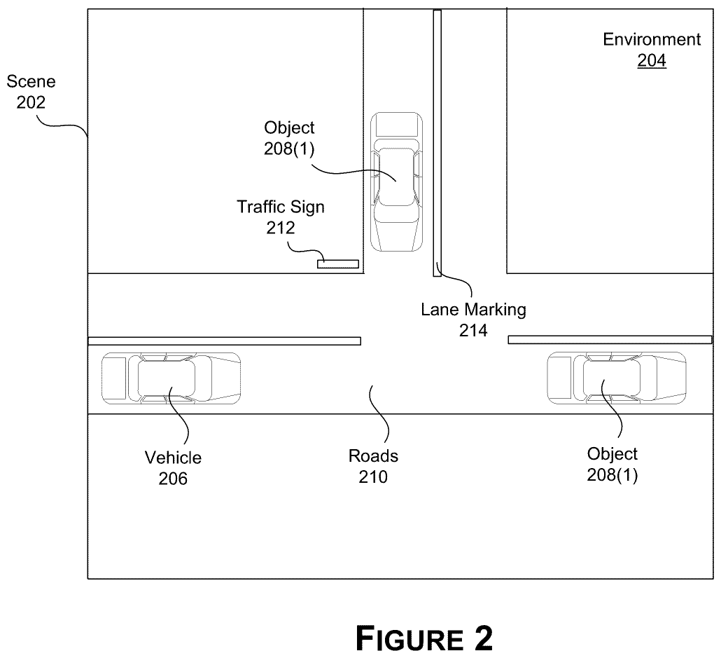

For instance, FIG. 2 illustrates an example of a scene 202 associated with an environment 204, in accordance with some examples of the present disclosure. As shown, the scene 202 includes and/or indicates a position of a vehicle 206, a position of a first object 208(1) (e.g., a second vehicle), a position of a second object 208(2) (e.g., a third vehicle), locations of roads 210 (although only one is labeled for clarity reasons), a location of a traffic sign 212, and locations of lane markings 214 (although only one is labeled for clarity reasons). In some examples, the scene 202 may further indicate which object is being analyzed for determining a responsibility allocation, such as the first object 208(1). In some examples, the scene may indicate the type of traffic sign 212, which may include a stop sign in the example of FIG. 2, and/or the type of lane marking 214.

While the example of FIG. 2 illustrates the vehicle 206 as being located proximate to a left-edge of the scene 202, in other examples, the vehicle 206 may be located at a different position within the scene 202. For instance, the vehicle 206 may be located at a center position of the scene 202, a top-edge of the scene 202, a right-edge of the scene 202, a bottom-edge of the scene 202, a corner position of the scene 202, and/or any other position. For example, in some embodiments, the representation (e.g., image) of the scene may be generated with the vehicle 206 (e.g., the vehicle for which a responsibility allocation is being determined) at a center of the representation (e.g., using a center point of a rig coordinate system of the vehicle).

Referring back to the example of FIG. 1, the process 100 may include inputting the parameter data 106 and/or the scene data 108 into a neural network(s) 110 that is trained to determine responsibility allocations between vehicles and objects. For instance, and as shown, the neural network(s) 110 may process the parameter data 106 and/or the scene data 108 and, based on the processing, output responsibility data 112 representing a level of responsibility associated with the vehicle and object pair. In some examples, and as described in more detail herein, the responsibility data 112 may represent a value (e.g., a gamma value) that indicates the level of responsibility. In such examples, a first value(s) (e.g., 0) may indicate an evenly shared level of responsibility, a second value(s) (e.g., a negative value(s)) may indicate a decreased level of responsibility associated with the vehicle and/or an increased level of responsibility associated with the object, and a third value(s) (e.g., a positive value(s)) may indicate an increased level of responsibility associated with the vehicle and/or a decreased level of responsibility associated with the object.

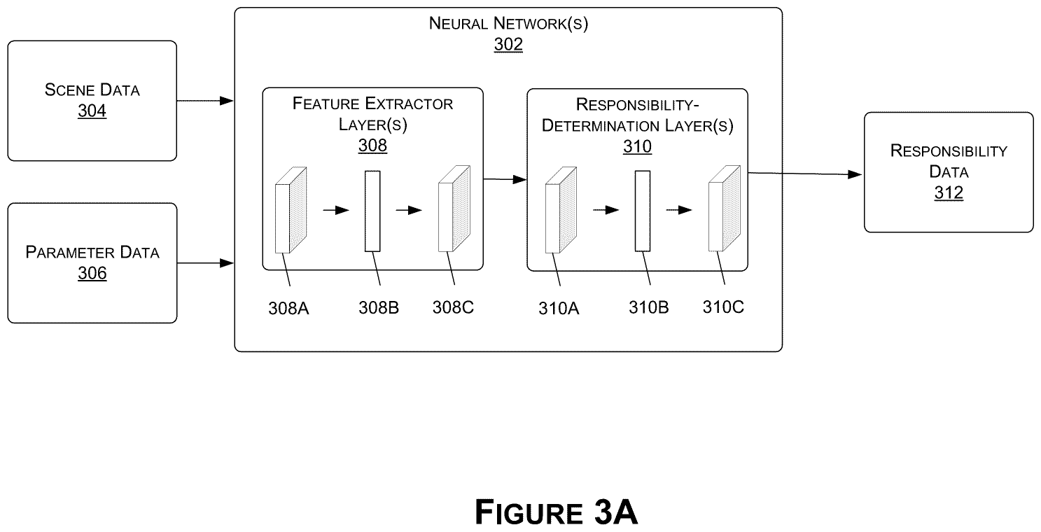

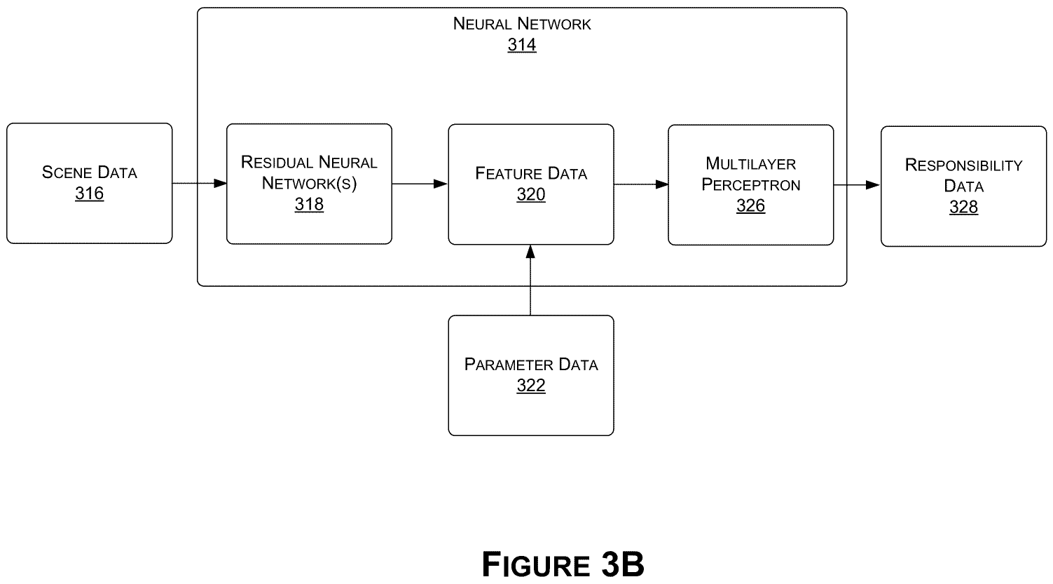

For instance, FIG. 3A illustrates an example neural network(s) 302 (which may represent, and/or include, the neural network(s) 110) for processing data in order to determine responsibility allocations, in accordance with some embodiments of the present disclosure. The neural network(s) 302 may be one example of a machine learning model that may be used to perform one or more of the processes described herein. The neural network(s) 302 may include or be referred to as a convolutional neural network and thus may alternatively be referred to herein as a convolutional neural network 302, a convolutional network 302, or a CNN 302.

As described herein, the neural network(s) 302 may use scene data 304 (which may represent, and/or include, the scene data 108) and/or parameter data 306 (which may represent, and/or include, the parameter data 106) as an input. The scene data 304 and/or the parameter data 306 may be input into a feature extractor layer(s) 308 of the neural network(s) 302. The feature extractor layer(s) 308 may include any number of layers 308, such as the layers 308A-308C. One or more of the layers 308 may include an input layer. The input layer may hold values associated with the scene data 304 and/or the parameter data 306. For example, when the scene data 304 is an image(s) (e.g., a top-down image(s)), the input layer may hold values representative of the raw pixel values of the image(s) as a volume (e.g., a width, W, a height, H, and color channels, C (e.g., RGB), such as 32.times.32.times.3), and/or a batch size, B (e.g., where batching is used).

One or more layers 308 may include convolutional layers. The convolutional layers may compute the output of neurons that are connected to local regions in an input layer (e.g., the input layer), each neuron computing a dot product between their weights and a small region they are connected to in the input volume. A result of a convolutional layer may be another volume, with one of the dimensions based on the number of filters applied (e.g., the width, the height, and the number of filters, such as 32×32×12, if 12 were the number of filters).

One or more of the layers 308 may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers 308 may include a pooling layer. The pooling layer may perform a down-sampling operation along the spatial dimensions (e.g., the height and the width), which may result in a smaller volume than the input of the pooling layer (e.g., 16×16×12 from the 32×32×12 input volume). In some examples, the neural network 308 may not include any pooling layers. In such examples, other types of convolution layers may be used in place of pooling layers. In some examples, the feature extractor layer(s) 308 may include alternating convolutional layers and pooling layers.

One or more of the layers 308 may include a fully connected layer. Each neuron in the fully connected layer(s) may be connected to each of the neurons in the previous volume. The fully connected layer may compute class scores, and the resulting volume may be 1×1×N (where N is a number of classes). In some examples, the feature extractor layer(s) 308 may include a fully connected layer, while in other examples, the fully connected layer of the neural network(s) 302 may be the fully connected layer separate from the feature extractor layer(s) 308. In some examples, no fully connected layers may be used by the feature extractor layer(s) 308 and/or the neural network(s) 302 as a whole, in an effort to increase processing times and reduce computing resource requirements. In such examples, where no fully connected layers are used, the neural network(s) 302 may be referred to as a fully convolutional network.

One or more of the layers 308 may, in some examples, include deconvolutional layer(s). However, the use of the term deconvolutional may be misleading and is not intended to be limiting. For example, the deconvolutional layer(s) may alternatively be referred to as transposed convolutional layers or fractionally strided convolutional layers. The deconvolutional layer(s) may be used to perform up-sampling on the output of a prior layer. For example, the deconvolutional layer(s) may be used to up-sample to a spatial resolution that is equal to the spatial resolution of the input images (e.g., the scene data 304) to the neural network(s) 302, or used to up-sample to the input spatial resolution of a next layer.

Although input layers, convolutional layers, pooling layers, ReLU layers, deconvolutional layers, and fully connected layers are discussed herein with respect to the feature extractor layer(s) 308, this is not intended to be limiting. For example, additional or alternative layers 308 may be used in the feature extractor layer(s) 308, such as normalization layers, SoftMax layers, and/or other layer types.

The output of the feature extractor layer(s) 308 may be an input to a responsibility-determination layer(s) 310. The responsibility-determination layer(s) 310A-C may use one or more of the layer types described herein with respect to the feature extractor layer(s) 308. As described herein, the responsibility-determination layer(s) 310 may not include any fully connected layers, in some examples, to reduce processing speeds and decrease computing resource requirements. In such examples, the responsibility-determination layer(s) 310 may be referred to as fully convolutional layers.

Different orders and numbers of the layers 308 and 310 of the neural network(s) 302 may be used, depending on the embodiment. In addition, some of the layers 308 and 310 may include parameters (e.g., weights and/or biases)—such as the feature extractor layer(s) 308 and/or the responsibility-determination layer(s) 310—while others may not, such as the ReLU layers and pooling layers, for example. In some examples, the parameters may be learned by the neural network(s) 302 during training. Further, some of the layers 308 and 310 may include additional hyper-parameters (e.g., learning rate, stride, epochs, kernel size, number of filters, type of pooling for pooling layers, etc.)—such as the convolutional layer(s), the deconvolutional layer(s), and the pooling layer(s)—while other layers may not, such as the ReLU layer(s). Various activation functions may be used, including, but not limited to, ReLU, leaky ReLU, sigmoid, hyperbolic tangent (tanh), exponential linear unit (ELU), etc. The parameters, hyper-parameters, and/or activation functions are not to be limited and may differ depending on the embodiment.

In any example, the output of the neural network(s) 302 includes responsibility data 312 (which may represent, and/or include, the responsibility data 112) indicating the level(s) of responsibility associated with the vehicle and object pair(s).

Additionally, FIG. 3B illustrates an example neural network(s) 314 (which may represent, and/or include, the neural network(s) 110 and/or the neural network(s) 302) for processing data in order to determine responsibility allocations, in accordance with some embodiments of the present disclosure. As shown, scene data 316 (which may represent, and/or include, the scene data 108 and/or the scene data 304) may be input into a residual neural network(s) 318 of the neural network(s) 314. The residual neural network(s) 318 may be trained to process the scene data 316 and, based on the processing, output feature data 320. The feature data 320 may include any number of features associated with the scene data 316, such as 126 features, 256 features, 512 features, and/or the like.

The features represented by the feature data 320 may then be concatenated or fused with a parameter(s) represented by the parameter data 322 (which may represent, and/or include, the parameter data 106 and/or the parameter data 306). The concatenated (or fused, where fusion is performed) data may then be input into a multilayer perception (MLP) 326 of the neural network(s) 314. Based on processing the concatenated data, the MLP 326 may output responsibility data 328 (which may represent, and/or include, the responsibility data 112 and/or the responsibility data 312) indicating the level(s) of responsibility associated with the vehicle and object pair(s).

In some examples, one or more parameters may be chosen for the neural network(s) 314. For example, parameters, which are described in more detail below, may include λ₁=1, λ₂=10, λ₃=0.01, α=0.5, T=1, d=0.4, [symbol] ₁=0.1, [symbol] ₂=0.01, and θₘₐₓ=100°, where [symbol] ₁ and [symbol] ₂ are the negative slopes of the MLP's leaky ReLU activation functions and θₘₐₓ is used to filter the dataset such that interactions between vehicles whose headings are within ±θₘₐₓ may be considered.

Referring back to the example of FIG. 1, the process 100 may include an analysis component 114 that is configured to analyze the responsibility data 112 and/or control data 116 in order to determine one or more controls for the vehicle to perform. For instance, the analysis component 114 may be configured to determine whether the vehicle should perform one or more controls, represented by the control data 116, based on the level of responsibility represented by the responsibility data 112. As described herein, a control may include, but is not limited to, a velocity, an acceleration, a turning rate, any other control associated with the vehicle, and/or a combination thereof.

In some examples, the analysis component 114 uses one or more functions, such as one or more CBFs, to determine whether the vehicle is safe navigating using the control(s) based on the level of responsibility. For instance, the interaction between the vehicle and the object may be abstracted as a nonlinear system in the form of:

\dot{x}=ƒ(x)+g(x)u (1)

In equation (1), x∈X⊂ [symbol] ⁿ u∈U⊂ [symbol] ^{m} represent the states and inputs of the system and take values in the compact sets X and U, respectively. In some examples, drive dynamics ƒ: [symbol] ⁿ→ [symbol] ⁿ and input matrix g: [symbol] ⁿ→ [symbol] ^{n×m} are locally Lipschitz continuous. Given a state-feedback controller k: [symbol] ⁿ→ [symbol] ^{m}, the closed-loop dynamics may be:

\dot{x}=ƒ_{d}(x)=ƒ(x)+g(x)k(x) (2)

In some examples, safety is defined as a forward-invariance of a set C⊂ [symbol] ⁿ and reviews CBFs as a tool for synthesizing safe controllers. A set C⊆X is forward invariant if for one or more (e.g., every) x(0)∈C, the solution of equation (2) satisfies x(t)∈C for all t≥0. Additionally, the system of equation (2) may be safe with respect C if C is forward invariant.

Next, let the set C be the 0-superlevel set of some continuously differentiable function h: [symbol] ⁿ→ [symbol] with 0 is a regular value, such as with equation:

C [symbol] {x∈X|h(x)≥0} (3)

In equation (3), h is deemed a CBF if it also satisfies the following definition. Specifically, let C⊆X be the 0-superlevel set of some continuously differentiable function h: [symbol] ⁿ→ [symbol] with 0 as a regular value. The function h is a CBF for equation (1) if there exists an extended class k_{∞} of equation (2) such that for one or more (e.g., all) x∈C:

$$\\ \begin{matrix}{sup}_{u ∈ U} {L}_{f} h ( x ) + {L}_{g} h ( x ) u \geq - α ( h ( x ) ) where & ( 4 )\end{matrix}$$

$$\\ \begin{matrix}{L}_{f} h ( x ) + {L}_{g} h ( x ) u is \frac{dh}{dt} ( x , u ) & ( 5 )\end{matrix}$$

$$\\ \begin{matrix}{L}_{f} h ( x ) is \frac{\partial h}{\partial x} f ( x ) & ( 6 )\end{matrix}$$

$$\\ \begin{matrix}{L}_{g} h ( x ) is \frac{\partial h}{\partial x} g ( x ) & ( 7 )\end{matrix}$$

In some examples, Lie derivative notation is used to represent the partial derivatives

$$\\ {L}_{f} h ( x ) {=}^{△} \frac{\partial h}{\partial x} f ( x ) and {L}_{g} h ( x ) {=}^{△} \frac{\partial h}{\partial x} g ( x ) .$$

In some examples, the CBF constraint of equation (4) limits

$$\\ \frac{dy}{dx}$$

and prevents h from decreasing along the trajectory when h(x)=0, thus rendering C a forward invariant of equation (2). By designating h such that one or more (e.g., all) x∈C are considered safe, guaranteeing forward-invariance of C is equivalent to guaranteeing safety.

In some examples, given a set C⊆X defined as the 0-superlevel set of a continuously differentiable function h: [symbol] ⁿ→ [symbol] with 0 a regular value, if h is a CBF, then any locally Lipschitz controller k: [symbol] ⁿ→ [symbol] ^{m} that satisfies equation (4) for one or more (e.g., all) x∈C, renders equation (2) safe with respect to C.

In some examples, similar processes may be used to extend the CBF framework to a decentralized multi-agent setting for determining shared responsibility between at least a vehicle and one or more other objects. For instance, and for a decentralized multi-agent CBF, the dynamics of equation (1) may be extended to multiple agents by:

\dot{x}ᵢ=ƒᵢ(xᵢ)+gᵢ(xᵢ)uᵢ (8)

In equation (8), xᵢ∈Xᵢ⊂ [symbol] ⁿ^{ᵢ}, uᵢ∈Uᵢ⊂ [symbol] ^{m}^{ᵢ},ƒᵢ: [symbol] ⁿ^{ᵢ}→ [symbol] ⁿ^{ᵢ}, and gᵢ: [symbol] ⁿ^{ᵢ}→ [symbol] ^{m}^{ᵢ} represent the state, input, drift, and actuation matrix of agent i, respectively. For the entire system of N∈ [symbol] agents, let x=[x₁^{T} . . . x_{N}^{T}]^{T} denote the concatenated state and the dynamics for x be denoted as:

$$\\ \begin{matrix}\dot{x} = [ \begin{matrix}{f}_{1} ( {x}_{1} ) \\ ⋮ \\ {f}_{N} ( {x}_{N} )\end{matrix} ] + [ \begin{matrix}{g}_{1} ( {x}_{1} ) \\ ⋮ \\ {g}_{N} ( {x}_{N} )\end{matrix} ] [ \begin{matrix}{u}_{1} \\ ⋮ \\ {u}_{N}\end{matrix} ] where & ( 9 )\end{matrix}$$

$$\\ \begin{matrix}[ \begin{matrix}{f}_{1} ( {x}_{1} ) \\ ⋮ \\ {f}_{N} ( {x}_{N} )\end{matrix} ] is f ( x ) & ( 10 )\end{matrix}$$

$$\\ \begin{matrix}[ \begin{matrix}{g}_{1} ( {x}_{1} ) \\ ⋮ \\ {g}_{N} ( {x}_{N} )\end{matrix} ] is g ( x ) & ( 11 )\end{matrix}$$

$$\\ \begin{matrix}[ \begin{matrix}{u}_{1} \\ ⋮ \\ {u}_{N}\end{matrix} ] is u & ( 12 )\end{matrix}$$

In equations (9)-(12), 0 is a regular value of h if

$$\\ h ( x ) = 0 \frac{\partial h}{\partial x} \neq 0.$$

A continuous function α: [symbol] _{≥0}→ [symbol] _{≥0} is a class K_{∞} function if α(0)=0, α is strictly monotonically increasing, and lim_{c→∞}α(c)=∞. A continuous function α: [symbol] → [symbol] is an extended K_{∞} if α(0)=0, α is strictly monotonically increasing, lim_{c→∞}α(c)=∞ and lim_{c→-∞}α(c)=−∞.

If the multi-agent system is controlled by a centralized controller, the CBF inequality may be checked directly and used as a constraint in convex programs to obtain safe inputs. However, centralized control may be unrealizable due to communication and scalability issues as well as the presence of a decentralized variant of the CBF constraint in equation (4) and the assumption that each agent may measure the states of the other agents, but independently generate their own input according to some controller unknown to the other agents.

One method for retaining safety guarantees in the context of decentralized control is to ensure robustness with respect to some (e.g., all) possible, including worst-case, controls of the other agent(s) such in equation (4). In this case, the constraint of equation (4) from the perspective of the agent i (e.g., the vehicle) may become:

$$\\ \begin{matrix}{sup}_{{u}_{i} ∈ {U}_{i}} {inf}_{{u}_{j} ∈ {U}_{j} , j \neq i} {L}_{f} h ( x ) + {L}_{g} h ( x ) u \geq - α ( h ( x ) ) & ( 13 )\end{matrix}$$

In some examples, this may be a conservative constraint which measures the safety of the system even when other agents (e.g., other objects, such as vehicles) act adversarial to the agent. In some examples, despite safety-guarantees, worst-case constraints like in equation (7) are highly conservative and prevent fluent behaviors. As such, it may be desirable to find a less conservative safety constraint that is more cognizant of the social interactions between agents (e.g., a vehicle and objects) even when the controllers of the of the other agents are unknown. For this reason, a CBF framework that models social responsibility may be used.

For instance, in multi-agent systems of human actors, the responsibility for maintaining safety is typically shared amongst drivers. For example, drivers may exhibit social behavior in crowd navigation and driving where burden of maintaining safety is distributed amongst all drivers. Equipped with the notion that agents share the responsibility of maintaining safety, a move from worst-case behavioral assumption may occur. Instead, learning the responsibility allocation from data may be used. This may be done using responsibility allocation functions.

For instance, a function γ: [symbol] × [symbol] ⁿ→ [symbol] is a responsibility allocation function for N∈ [symbol] on X if for one or more (e.g., all) x∈X:

$$\\ \begin{matrix}{\sum }_{i ∈ \{ 1 , … , N \}} γ ( i , x ) \geq 0 & ( 14 )\end{matrix}$$

For an agent i in a multi-agent system at state x∈X, γ(i, x)>0 indicates increased responsibility, γ(i, x)=0 indicates evenly shared responsibility, and γ(i, x)<0 indicates decreased responsibility. The sum of γ(i, x) may be lower bounded by 0 and ensure that the total allocated responsibility should be greater than or equal to that of even sharing. Using these responsibility allocation functions, responsibility-aware CBF (RA-CBF) may consider responsibility allocation in decentralized multi-agent safety constraints.

For instance, and for RA-CBF, let C⊆X be the 0-superlevel set of some continuously differentiable function h: [symbol] ⁿ→ [symbol] with 0 as a regular value. Additionally, let γ: [symbol] × [symbol] ⁿ→ [symbol] be a responsibility allocation function for N and X. The function h is a RA=CBF for the system of equation (9) if there exists an extended class K_{∞} function α such that for one or more (e.g., all) x∈C and one or more (e.g., all) i∈{1, . . . , N}:

$$\begin{matrix}sup \\ {u}_{i} ∈ {U}_{i}\end{matrix} {L}_{{g}_{i}} h ( x ) {u}_{i} + \frac{1}{N} ( ∝ ( h ( x ) ) + {L}_{f} h ( x ) ) - γ ( i , x ) \geq 0 \qquad ( 15 )$$

$$where {L}_{{g}_{i}} h ( x ) {u}_{i} + \frac{1}{N} ( ∝ ( h ( x ) ) + {L}_{f} h ( x ) ) is {c}_{i} ( x ) {=}^{Δ} \qquad ( 16 )$$

$${L}_{{g}_{i}} h ( x ) {u}_{i} + \frac{1}{N} ( ∝ ( h ( x ) ) + {L}_{f} h ( x ) ) - γ ( i , x ) is a RA - CBF Contraint ( i , x , {u}_{i} , γ ) {=}^{Δ} \qquad ( 17 )$$

In some examples, RA-CBFs are presented for N agents. In some examples, multi-agent systems may enforce pairwise CBF constraints between one or more agents (e.g., each agent), where the number of constraints enforced by the agent i grows linearly with the number of agents. In this case, there would be several pairwise RA-CBF constraints with N=2.

For responsibility-aware safety, given a set C⊆X defined as the 0-superlevel set of a continuously differentiable function h: [symbol] ⁿ→ [symbol] with 0 a regular value, if the function h is a RA-CBF with the responsibility allocation function γ: [symbol] × [symbol] ⁿ→ [symbol] for N on X, then any locally Lipschitz controller k: [symbol] ⁿ→ [symbol] ^{m} that satisfies equation (15) for one or more (e.g., all) x∈C, renders the systems of equation (2) safe with respect to C.

For instance, let

$${c}_{i} ( x ) {=}^{Δ} {L}_{{g}_{i}} h ( x ) {k}_{i} ( x ) + \frac{1}{N} ( ∝ ( h ( x ) ) + {L}_{f} h ( x ) )$$

for all i∈{1, . . . , N}. Since the kᵢ satisfies equation (15), it follows that for any i∈{1, . . . , N}:

$$0 \geq - {c}_{i} ( x ) + γ ( i , x ) , \qquad ( 18 )$$

$$\geq - {\sum }_{i ∈ \{ 1 , ... , N \}} {c}_{i} ( x ) + {\sum }_{i ∈ \{ 1 , ... , N \}} γ ( i , x ) , \qquad ( 19 )$$

$$\geq - {\sum }_{i ∈ \{ 1 , ... , N \}} {c}_{i} ( c ) \qquad ( 20 )$$

Inequality of equation (19) follows from the decentralized constraint of equation (15) for all i and equation (20) holds since γ is a responsibility allocation function for N on X. Since the final inequality of equation (20) is equivalent to the centralized CBF constraint of equation (4), this implies the safety of equation (2) with respect to C. More specifically, and in some examples, instead of considering the worst-case inputs from other agents, the RA-CBF approaches γ(i, x) to capture how social norms effect the contribution of agent i to decentralized multi-agent safety. Also, in some examples, instead of explicitly considering the uncertainty in the other agents' actions, one prospective of the responsibility allocation function is that it models a bound on the projection of the other agents' inputs into the CBF time derivative. As such, the other agents may be learned as a scalar rather than predicting their uncertain trajectories.

In some examples, the responsibility model may use a multiplicative term for driftless systems ƒ(x)≡0. By using this additive term, the model is generally applicable to controlling affine systems and is capable of accounting for the effect of responsibility even when the uncontrolled components of the CBF constraint are unsafe, such as ∝(h)+L_{f}h(x)≤0.

These RA-CBFs may then be applied to vehicles, such as autonomous and/or semi-autonomous vehicles. For instance, individual agents may be modeled by:

$$[ \begin{matrix}{\dot{x}}_{i} \\ {\dot{y}}_{i} \\ {\dot{v}}_{i} \\ θ\end{matrix} ] = [ \begin{matrix}{v}_{i} cos ( {θ}_{i} ) \\ {v}_{i} sin ( {θ}_{i} ) \\ 0 \\ 0\end{matrix} ] + [ \begin{matrix}0 & 0 \\ 0 & 0 \\ 1 & 0 \\ 0 & 1\end{matrix} ] [ \begin{matrix}{a}_{i} \\ {ω}_{i}\end{matrix} ] \qquad ( 21 )$$

$$where [ \begin{matrix}{\dot{x}}_{i} \\ {\dot{y}}_{i} \\ {\dot{v}}_{i} \\ θ\end{matrix} ] represents {\dot{x}}_{i} \qquad ( 22 )$$

$$[ \begin{matrix}{v}_{i} cos ( {θ}_{i} ) \\ {v}_{i} sin ( {θ}_{i} ) \\ 0 \\ 0\end{matrix} ] represents {f}_{i} ( {x}_{i} ) \qquad ( 23 )$$

$$[ \begin{matrix}0 & 0 \\ 0 & 0 \\ 1 & 0 \\ 0 & 1\end{matrix} ] represents {g}_{i} ( {x}_{i} ) \qquad ( 24 )$$

$$[ \begin{matrix}{a}_{i} \\ {ω}_{i}\end{matrix} ] represents {u}_{i} \qquad ( 25 )$$

In equation (21), (xᵢ, yᵢ)∈ [symbol] ², vᵢ, θᵢ, aᵢ, ωᵢ∈ [symbol] represent the position, velocity, yaw, acceleration, and yaw rate of the vehicle i, respectively.

In some examples, a safety metric is selected for autonomous and/or semi-autonomous applications. For instance, to define a safety function h: [symbol] ⁿ→ [symbol] , it may be assumed that one or more vehicles (e.g., all vehicles) maintain a minimum inter-vehicle distance d>0. As such, let dᵢⱼ: [symbol] ⁿ→ [symbol] be the minimum distance from agent i (e.g., the vehicle) to agent j (e.g., an object). A pairwise safe set between i and j may then be defined to include:

Cᵢⱼ={x∈X|dᵢⱼ(x)−d≥0} (26)

wherein dᵢⱼ(x)−d is hᵢⱼ(x) [symbol] (27)

In some examples, equation (26) is relative two degrees with respect to ∝ⱼ (e.g.,

$$\frac{dh}{dt} ,$$

is not directly affected by ∝ᵢ), and describes safety by considering the instantaneous current position. As such, a temporal aspect may be incorporated to ensure that a time derivative of hᵢⱼ is affected by both the vehicle's acceleration and angle rate. For instance, the current state may be forward projected using a backup controller k_{B}: [symbol] ⁿ^{ᵢ}→ [symbol] ^{m} over time interval [0, T] for T∈ [symbol] _{>0}. In some examples, for one or more (e.g., any) xᵢ(t)∈ [symbol] ⁿ^{ᵢ}, there exists a unique solution Ø:[0, T]→ [symbol] ⁿ satisfying:

$$\frac{d}{dt} {∅}_{i} ( τ ) = {f}_{i} ( ∅ ) ( τ ) + {g}_{i} ( ∅ ( τ ) ) {k}_{B} ( ∅ ( τ ) ) \qquad ( 28 )$$

$${∅}_{i} ( 0 ) = {x}_{i} ( t ) \qquad ( 29 )$$

The solution Ø starting at xᵢ(t) is the flow under xᵢ, and is denoted as φ_{τ}(xᵢ) [symbol] Øᵢ(τ). Using the flow φ and the distance function dᵢⱼ, the minimum distance that would be achieved during the interval [t, T+t] if k_{B} were the controller for the vehicle and the object includes:

$${h}_{ij}^{φ} ( x ) = \begin{matrix}min \\ τ ∈ [ 0 , T ]\end{matrix} {d}_{min} ( {φ}_{τ} ( {x}_{i} ) , {φ}_{τ} ( {x}_{j} ) ) - \underline{d} , \qquad ( 30 )$$

Where equation (30) may have an associated safe set Cᵢⱼ^{φ}⊆Cᵢⱼ⊂ [symbol] ⁿ for:

Cᵢⱼ^{φ}={x∈X|hᵢⱼ^{φ}(x)≥0} (31)

In some examples, a backup controller, k_{B}(xᵢ)=0 is chosen to approximate idling. Given these pairwise safe sets Cᵢⱼ^{φ}, a global safe set C^{φ}⊆Cᵢⱼ^{φ}⊆C_{i,j} may be defined for one or more (e.g., all) i≠j as:

$${C}_{i , j}^{φ} = {⋂}_{i \neq j} {C}_{i , j}^{φ} with h ( x ) = \begin{matrix}min \\ i \neq j\end{matrix} {C}_{i , j}^{φ} ( x ) \qquad ( 32 )$$

In some examples, the analysis component 114 may use at least equation (15) to analyze the responsibility data 112 and/or the control data 116 in order to determine the one or more controls for the vehicle to perform. For instance, the analysis component 114 may be configured to determine whether the vehicle should perform the control(s), represented by the control data 116, by inputting the level of responsibility (e.g., γ) represented by the responsibility data 112 and the control(s) (e.g., uᵢ) into equation (15). As described herein, a control may include, but is not limited to, a velocity, an acceleration, a turning rate, and/or the like associated with the vehicle. The analysis component 114 may then determine that the control(s) is safe when the output of equation (15) satisfies (e.g., is equal to or greater than) a value (e.g., 0) or determine that the control(s) is not safe when the output does not satisfy (e.g., is less than) the value. The analysis component 114 may then output safety constraint data 118 indicating whether the control(s) is safe and/or the output value from equation (15). In some examples, the analysis component 114 may perform similar processes for one or more (e.g., each) vehicle and object pair within the environment.

The process 100 may include a control component 120 determining the control(s) for the vehicle. For instance, in some examples, when the control(s) is determined not to be safe, such as based on one or more (e.g., all) of the outputs from equation (15) not satisfying the value, the control component 120 may determine one or more new controls for the vehicle to perform. The analysis component 114 may then analyze the new control(s), represented by the control data 116, using similar processes to determine whether the new control(s) is safe for the vehicle to perform. This process may then repeat until the analysis component 114 determines the analyzed control(s) is safe. The process may repeat until a single control is determined to be safe, or may repeat over some number of proposed controls, where one or more safe controls may be determined. When that occurs, the vehicle may then perform the safe control(s)—e.g., the vehicle may determine a single safe control, or may select a control from a number of safe controls. In an example, where no control is deemed safe, the vehicle may perform a safety maneuver (e.g., coming to a stop, moving to side of path or road, etc.), may hand control back to a driver (e.g., when in an autonomous mode), and/or may perform another operation.

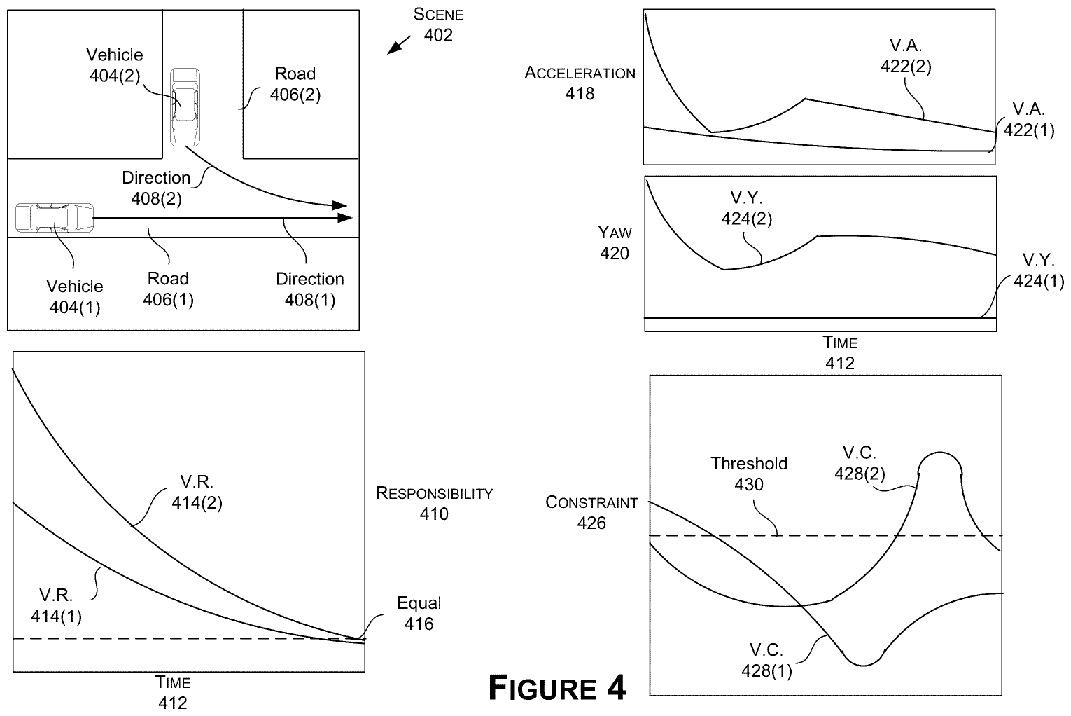

FIG. 4 illustrates an example of determining responsibility allocations between vehicles, in accordance with some examples of the present disclosure. As shown, a scene 402 of an environment may include a first vehicle 404(s) traveling along a first road 406(1) in a first direction 408(2) and a second vehicle 404(2) traveling along a second road 406(2). In the example of FIG. 4, the second vehicle 404(2) may be attempting to travel in a second direction 408(2) that causes the second vehicle 404(2) to navigate along the first road 406(1) and intersect with the first vehicle 404(1). Additionally, the intersection may include an uncontrolled intersection such that the vehicles 404(1)-(2) should yield before navigating.

FIG. 4 also illustrates a responsibility 410 associated with the vehicles 404(1)-(2) over a period of time 412 as the vehicles 404(1)-(2) are navigating in the environment. In some examples, a responsibility 414(1) associated with the first vehicle 404(1) and/or a responsibility 414(2) associated with the second vehicle 404(2) may be determined using one or more of the processes described herein, such as using the neural network(s) 110, the neural network(s) 302, and/or the neural network(s) 314. For instance, as time progresses, the first vehicle 404(1) may determine the responsibilities 414(1) by inputting, into the neural network(s) 110, scene data 108 representing updated scenes associated with the first vehicle 404(1) (e.g., where the first vehicle 404(1) is in the center of the scene) and parameter data 106 representing updated parameters of the first vehicle 404(1) and/or the second vehicle 404(2) (e.g., the positions of the first vehicle 404(1), the velocities of the first vehicle 404(1), the directions of travel of the first vehicle 404(1), etc.). Additionally, the second vehicle 404(2) may determine the responsibilities 414(2) by inputting, into the neural network(s) 110, scene data 108 representing updated scenes associated with the second vehicle 404(2) (e.g., where the second vehicle 404(2) is in the center of the scene) and parameter data 106 representing updated parameters of the second vehicle 404(2) and/or the first vehicle 404(1) (e.g., the positions of the second vehicle 404(2), the velocities of the second vehicle 404(2), the directions of travel of the second vehicle 404(2), etc.).

As shown, at a current time of the scene, which is represented by the left boundary of the responsibility 410 graph, the responsibility 414(2) for the second vehicle 404(2) is greater than the responsibility 414(1) for the first vehicle 404(1). This may be because the second vehicle 404(2) is turning onto the road 406(1) for which the first vehicle 404(1) is currently navigating, which means the second vehicle 404(2) has more responsibility to avoid the collision. Next, as the second vehicle 404(2) begins to navigate along the second direction 408(2), the responsibilities 414(1) for the first vehicle 404(1) and the responsibilities 414(2) for the second vehicle 404(2) may begin to get closer together. This may be because the vehicle 404(1)-(2) include an equal amount of responsibility 410 the closer the vehicles 404(1)-(2) get to one another.

The example of FIG. 4 also illustrates an equal 416 line associated with the responsibility 410. In some examples, the equal 416 line may correspond to a responsibility γ of a specific value (e.g., 0). For instance, and as described herein, when the responsibility 410 is greater than the equal 416 line, then the vehicle 404(1)-(2) has a greater responsibility to avoid the collision. Additionally, when the responsibility 410 is less than the equal 416 line, then the vehicle 404(1)-(2) has less responsibility to avoid the collision. Furthermore, when the responsibility is equal to the equal 416 line, then the vehicle 404(1)-(2) has an equal amount of responsibility to avoid the collision.

FIG. 4 further illustrates controls associated with the vehicles 404(1)-(2) while navigating over the period of time 412. The controls may include an acceleration 418 and a yaw rate 420. For instance, the first vehicle 404(1) may start with a moderate acceleration 422(1) and then lower the acceleration 422(1) over the period of time 412. The second vehicle 404(2) may start with a high acceleration 422(2) (e.g., to start from a stopped position), then lower the acceleration 422(2), increase the acceleration 422(2), and again lower the acceleration 422(2) over the period of time 412. Additionally, the first vehicle 404(1) may keep a constant yaw rate 424(1) since the first vehicle 404(1) is navigating in a straight line. However, the second vehicle 404(2) may change the yaw rate 424(2) in order to navigate along the second direction 408(2) when making the turn.

Finally, FIG. 4 illustrates a constraint 426 for the vehicles 404(1)-(2) over the period of time 412. In some examples, the vehicles 404(1)-(2) may determine the constraint 426 using equation (15). For instance, the first vehicle 404(1) may determine constraints 428(1) associated with the first vehicle 404(1) by inputting the responsibilities 414(1), the accelerations 422(1), and the yaw rates 424(1) into equation (15). The second vehicle 404(2) may also determine constraints 428(2) associated with the second vehicle 404(2) by inputting the responsibilities 414(2), the accelerations 422(2), and the yaw rates 424(2) into equation (15). A threshold constraint 430 is also illustrated, such as 0.

As shown, the constraints 428(1) associated with the first vehicle 404(1) are higher than the constraints 428(2) associated with the second vehicle 404(2) in the beginning, but then switch over the period of time 412. This may be because the first vehicle 404(1) continues accelerating even though the second vehicle 404(2) is beginning to navigate on the first road 406(1) and in the path of the first vehicle 404(1). As such, by continuing to accelerate, the output of equation (15) may begin to decrease further into negative values since the first vehicle 404(1) should decelerate, instead of accelerating, in order to avoid the collision with the second vehicle 404(2).

More specifically, once the second vehicle 404(2) enters the first road 406(1) for which the first vehicle 404(1) is navigating, equation (15) may output negative values for the constraints 428(1) based on controls (e.g., the accelerations 422(1) and the yaw rates 424(1)) that the first vehicle 404(1) is using to navigate. This may be because it is unsafe for the first vehicle 404(1) to navigate using those controls based on the associated responsibilities 414(1) for the first vehicle 404(1). As such, once the constraints 428(1) reached the threshold constraint 430, the first vehicle 404(1) should have updated one or more of the controls in order to avoid a collision with the second vehicle 404(2).

In some examples, the vehicles 404(1)-(2) may be performing the processes of FIG. 4, such as determining the responsibilities 414(1)-(2) and the constraints 428(1)-(2), while navigating along the environment. For instance, and as described herein, the vehicles 404(1)-(2) may perform such processes in order to safely determine a control(s) for navigating (although the vehicle(s) 404(1)-(2) would determine a control(s) such that the constraints 428(1)-(2) remained above the threshold constraint 430 while navigating). In some examples, a system(s) may perform the processes of FIG. 4 in order to analyze an event that already occurred. For instance, if there was a collision between the vehicles 404(1)-(2), then the system(s) may perform these processes to determine or estimate which vehicle 404(1)-(2) was most at fault for causing the collision (e.g., the vehicle that had the highest levels of responsibility before and/or during the collision).

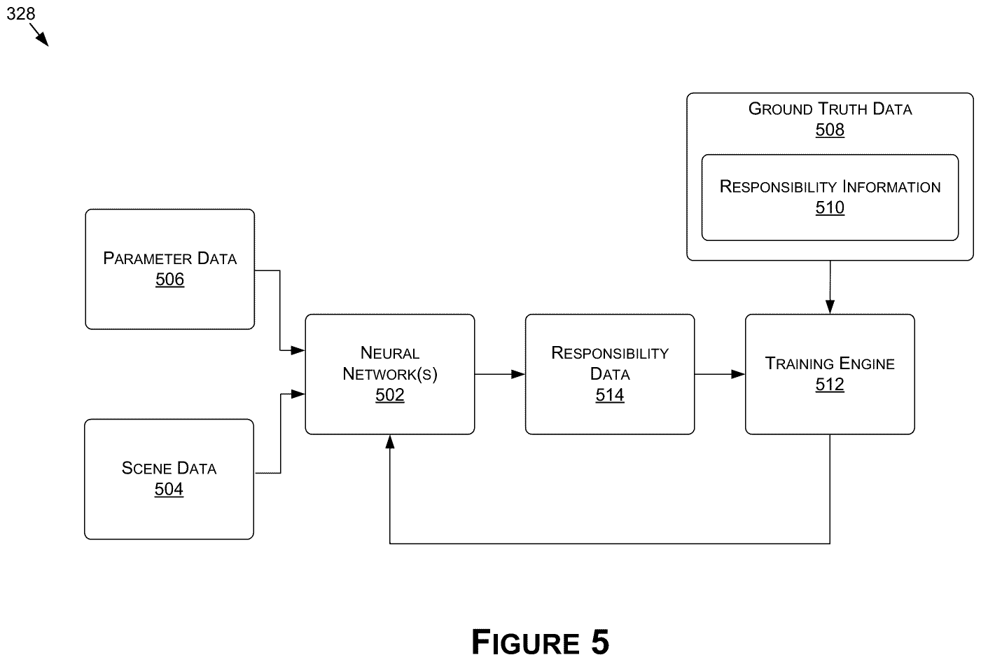

Now referring to FIG. 5, FIG. 5 is a data flow diagram illustrating a process 500 for training a neural network(s) 502 (which may represent, and/or include, the neural network(s) 110, the neural network(s) 302, and/or the neural network(s) 314) for determining responsibility allocations, in accordance with some embodiments of the present disclosure. As shown, the neural network(s) 502 may be trained using scene data 504 (which may be similar to the scene data 108) and parameter data 506 (which may be similar to the parameter data 106).

As described herein, and for a single vehicle and object pair, the parameter data 506 may represent a position of the vehicle within the environment, an acceleration of the vehicle, a velocity of the vehicle, a direction of travel of the vehicle, a turning rate of the vehicle, a position of the object within the environment (which may be relative to the vehicle), an acceleration of the object, a velocity of the object, a turning rate of the object, a classification of the object, and/or any other parameters. Additionally, the scene data 504 may represent a scene(s), where an individual scene indicates the position of the vehicle, the position of the object, and traffic features (e.g., a road(s), a traffic sign(s), a road marking(s), etc.), such as similar to the scene 202 of FIG. 2. In some examples, the scene data 504 is represented using a top-down (BEV) perspective of the environment. In some examples, one or more scenes (e.g., each scene) represented by the scene data 504 is associated with parameters represented by the parameter data 506.

The neural network(s) 502 may be trained using the scene data 504 and/or the parameter data 506 as well as corresponding ground truth data 508. The ground truth data 508 may include annotations, labels, masks, and/or the like. For example, in some embodiments, the ground truth data 508 may include responsibility information 510. In some examples, the responsibility information 510 may indicate (e.g., human-estimated) levels of responsibility for the vehicles represented by the scene data 504.

The ground truth data 508 may be generated within a drawing program (e.g., an annotation program), a computer aided design (CAD) program, a labeling program, another type of program suitable for generating the ground truth data 508, and/or may be hand drawn, in some examples. In some examples, the ground truth data 508 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 512 may use one or more loss functions that measure loss (e.g., error) in responsibility data 514 output by the neural network(s) 502 as compared to the ground truth data 508. As described herein, the responsibility data 514 may indicate the levels of responsibility associated with the vehicle, such as for each vehicle and object pair within the scenes. Any type of loss function may be used, such as cross entropy loss, mean squared error, mean absolute error, mean bias error, and/or other loss function types. In some examples, backward pass computations may be performed to recursively compute gradients of the loss function(s) with respect to training parameters. In some examples, weight and biases of the neural network(s) 502 may be used to compute these gradients.

For example, the function y for responsibility may be learned from demonstrations, such as by a known set C and associated CBF h. For instance, assume that agent i (e.g., the vehicle) strives to minimize some unknown function Qᵢ: [symbol] ^{n×m}→ [symbol] and does so according to a constrained optimal control policy:

$${k}_{i} ( x ) = \begin{matrix}arg min \\ {u}_{{i}_{∈}} {U}_{i}\end{matrix} {Q}_{i} ( {x}_{i} , {u}_{i} ) \qquad ( 33 )$$

Where equation (33) is subject to constrains (i, x, u, y)≥0 and Qᵢ(xᵢ, uᵢ) represents the cost of agent i for taking action uᵢ at state xᵢ. In some examples, although the cost function of one or more agents (e.g., each agent) is unknown, it may be assumed that the agents obey the RA-CBF constraint for some γ that will be learned.

For instance, let D={u^{k}, x^{k}}ₖ₌₁^{N}^{_{d}} be a dataset of state-input pairs gathered from expert (e.g., human) demonstrations where N_{d} represents the total number of data points collected. Since the cost of function Qᵢ may vary during data collection, it is possible for a state to have several associated expert inputs. As such, in some examples, the responsibility allocation function γ may be determined such that the RA-CBF constraint is satisfied for one or more (e.g., all) state-input pairs in the expert demonstration D. For instance, the constraint optimization may include:

$${y}^{*} = \begin{matrix}arg min \\ γ\end{matrix} ‖ γ ‖ \qquad ( 34 )$$

$$subject to RA - CBF Constraint ( i , x , u , γ ) \geq 0 , i = 1 , ... , N \qquad ( 35 )$$

$${\sum }_{i ∈ \{ 1 , ... , N \}} γ ( i , x ) \geq 0 , for all ( x , u ) ∈ 𝒟 \qquad ( 36 )$$

In equation (34), the constraints enforce satisfaction of the RA-CBF and ensure γ is a responsibility allocation function.

In some examples, to find an approximate solution to the problem, a loss function may be used, such as:

$$L ( D , γ ) = ‖ γ ‖ + {λ}_{1} {\sum }_{( x , u ) ∈ 𝒟} {\sum }_{i = 1}^{N} {[ - {c}_{i} ( x ) + γ ( i , x ) ]}_{+} + {λ}_{2} {\sum }_{( x , u ) ∈ 𝒟} {[ {\sum }_{i = 1}^{N} - {γ}_{i} ( i , x ) ]}_{+} \qquad ( 37 )$$

In equation (37), λ₁, λ₂, and ∈ [symbol] _{>0} are hyperparameters which adjust the constraint relaxations and [·]₊ [symbol] max{·,0}. This loss function may be used to find approximate solutions to equation (34).

y*≈argmin L( [symbol] ,γ) (38)

In some examples, the maximum entropy model with the variant for continuous-time nonlinear systems presented may solve the optimization:

$${γ}_{reg}^{*} = arg max {\sum }_{( x , u ) ∈ 𝒟} 𝒫 ( u \vert x , γ ) \qquad ( 39 )$$

In some examples, the probability of a given u may be approximated by choosing disc(U) to be a finite discretization of U such as disc(U)={u∈U|δ[u/δ]} for some δ>0 where [·] rounds one or more (each) component to the nearest integer. As such, the approximate probability of an input uᵢ∈Uᵢ given the system state x and responsibility allocation γ is

$$𝒫 ( u \vert x , γ ) = \frac{{e}^{R ( x , u )}}{{Z}_{γ}} {γ}^{} ( x , u ) , {Z}_{γ} = {\sum }_{v ∈ disc ( {U}_{i} )} {e}^{R ( x , v )} {γ}^{} ( x , v ) \qquad ( 40 )$$

In equation (40), Z is the partition function, R: [symbol] ⁿ× [symbol] ^{m}→ [symbol] is a reward function, and [symbol] ^{γ}(x, u)→{0,1} indicates that the RA-CBF constraint satisfies x and u given γ.

In some examples, to maximize the likelihood of the demonstration of equation (40), the number of feasible inputs may be minimized while still retaining the feasibility of expert demonstrations. For instance, the total number of feasible inputs in disc(U) decreases as γ(i, x) increases regardless of R. As such, even without knowledge of the agents' reward functions, γ may be maximized while still maintaining the feasibility of the expert demonstrations by the following optimization problem:

$${γ}_{reg}^{*} \approx \begin{matrix}arg max \\ γ\end{matrix} {\sum }_{( x , u ) 𝒟} {\sum }_{t = 1}^{N} γ ( i , x ) \qquad ( 41 )$$

$$subject to RA - CGB Constraint ( i , x , u , γ ) \geq 0 ∈$$

Since the constraint feasibility on [symbol] is already accounted for in equation (37), this regularization may be added to the loss as:

$${L}_{reg} ( D , γ ) {=}^{Δ} L ( D , γ ) + {λ}_{3} {\sum }_{( x , u ) ∈ 𝒟} {\sum }_{i = 1}^{N} - γ ( i , x ) \qquad ( 42 )$$

In equation (42), a hyperparameter is γ₃∈ [symbol] _{>0}, which may be used in the final regularized optimization problem to estimate γ:

y*≈argmin L_{reg}( [symbol] ,γ) (43)

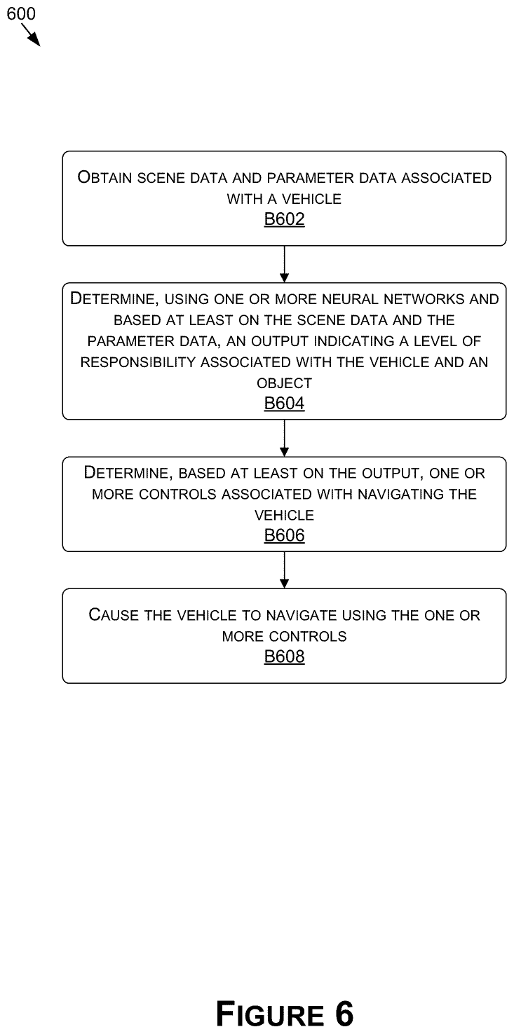

Now referring to FIG. 6, each block of method 600, described herein, comprises a computing process that may be performed using any combination of hardware, firmware, and/or software. For instance, various functions may be carried out by a processor executing instructions stored in memory. The method 600 may also be embodied as computer-readable instructions stored on computer storage media. The method 600 may be provided by a standalone application, a service or hosted service (standalone or in combination with another hosted service), or a plug-in to another product, to name a few. In addition, the method 600 is described, by way of example, with respect to FIG. 1. However, these methods may additionally or alternatively be executed by any one system, or any combination of systems, including, but not limited to, those described herein.

FIG. 6 is a flow diagram showing a method 600 for using a responsibility allocation to navigate a vehicle within an environment, in accordance with some embodiments of the present disclosure. The method 600, at block B602, may include obtaining scene data and parameter data associated with a vehicle. For instance, the vehicle may receive and/or generate the parameter data 106 and the scene data 108. As described herein, the parameter data 106 may represent a position of the vehicle within the environment, an acceleration of the vehicle, a velocity of the vehicle, a direction of travel of the vehicle, a turning rate of the vehicle, a position of the object within the environment (which may be relative to the vehicle), an acceleration of the object, a velocity of the object, a turning rate of the object, a classification of the object, and/or any other parameters. Additionally, the scene data 108 may represent a scene, where the scene indicates the position of the vehicle, the position of the object, and traffic features (e.g., a road(s), a traffic sign(s), a road marking(s), etc.). In some examples, the scene data 108 is represented using a top-down (BEV) perspective of the environment.

The method 600, at block B604, may include determining, using one or more neural networks and based at least on the scene data and the parameter data, an output indicating a level of responsibility associated with the vehicle and an object. For instance, the vehicle may input the parameter data 106 and the scene data 108 into the neural network(s) 110. As described herein, the neural network(s) 110 may be trained to determine a level of responsibility associated with the vehicle for the vehicle and object pair. In some examples, the level of responsibility may indicate that the vehicle and the object share an equal amount of the responsibility. In some examples, the level of responsibility may indicate that the vehicle shares a greater amount of the responsibility as compared to the object. Still, in some examples, the level of responsibility may indicate that the vehicle shares a lesser amount of the responsibility as compared to the object.

The method 600, at block B606, may include determining, based at least on the output, one or more controls associated with navigating the vehicle. For instance, the vehicle may use the level of responsibility to determine the control(s) for the vehicle to perform, such as to navigate safely and/or avoid a collision. In some examples, the vehicle determines the control(s) using an equation, such as equation (15). For instance, the vehicle may use the equation to analyze initial control(s) based on the level of responsibility. If the equation indicates that the initial control(s) is unsafe (e.g., a negate value is output), then the vehicle may select a different control(s) to perform. However, if the equation indicates that the initial control(s) is safe (e.g., a zero or positive value), then the vehicle may select the initial control(s) to perform.

The method 600, at block B608, may include causing the vehicle to navigate based at least on the one or more controls. For instance, the vehicle may navigate using the control(s). As described herein, by navigating using the control(s), the vehicle will avoid a collision with the object.

Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LIDAR sensor(s) 764, inertial measurement unit (IMU) sensor(s) 766 (e.g., accelerometer(s), gyro scope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), and/or other sensor types.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UNITS”), Global System for Mobile communication (“GSM”), IMT-CDMA Multi-Carrier (“CDMA2000”), etc. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RB GC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RB GC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LIDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 712 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LIDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LIDAR sensor(s) 764. The LIDAR sensor(s) 764 may be used for object and pedestrian detection, emergency braking, collision avoidance, and/or other functions. The LIDAR sensor(s) 764 may be functional safety level ASIL B. In some examples, the vehicle 700 may include multiple LIDAR sensors 764 (e.g., two, four, six, etc.) that may use Ethernet (e.g., to provide data to a Gigabit Ethernet switch).

In some examples, the LIDAR sensor(s) 764 may be capable of providing a list of objects and their distances for a 360-degree field of view. Commercially available LIDAR sensor(s) 764 may have an advertised range of approximately 700 m, with an accuracy of 2 cm-3 cm, and with support for a 700 Mbps Ethernet connection, for example. In some examples, one or more non-protruding LIDAR sensors 764 may be used. In such examples, the LIDAR sensor(s) 764 may be implemented as a small device that may be embedded into the front, rear, sides, and/or corners of the vehicle 700. The LIDAR sensor(s) 764, in such examples, may provide up to a 120-degree horizontal and 35-degree vertical field-of-view, with a 200 m range even for low-reflectivity objects. Front-mounted LIDAR sensor(s) 764 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 700. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LIDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(H) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using one or more neural networks and based at least on sensor data generated using one or more sensors of a machine in an environment, an output indicating one or more levels of responsibility, at least one level of responsibility including a level of responsibility allocated between the machine and an object in the environment;
determining, based at least on the output, one or more controls associated with navigating the machine; and
causing the machine to navigate based at least on the one or more controls.

2. The method of claim 1, further comprising:
determining, based at least on the sensor data, parameter data representing one or more of:
a first velocity associated with the machine;
a first location associated with the machine;
a first direction of travel associated with the machine;
a second velocity associated with the object;
a second location associated with the object; or
a second direction of travel associated with the object,
wherein the determining the output is based at least on the parameter data.

3. The method of claim 1, further comprising:
obtaining data representing a scene of the environment from a top-down perspective,
wherein the determining the output is further based at least on the data representing the scene.

4. The method of claim 1, wherein the output comprises one of:
a first output indicating that the machine has a greater level of responsibility than the object;
a second output indicating that the machine has a same level of responsibility as the object; or
a third output indicating that the machine has a lower level of responsibility than the object.

5. The method of claim 1, wherein the determining the one or more controls associated with the machine comprises:
determining one or more initial controls associated with navigating the machine;
determining, based at least on the output and the one or more initial controls, that a safety constraint associated with the machine and the object is not satisfied; and
updating, based at least on the safety constraint not being satisfied, the one or more initial controls to include the one or more controls.

6. The method of claim 1, wherein the determining the one or more controls associated with the machine comprises:
determining one or more initial controls associated with navigating the machine;
determining, based at least on the output and the one or more initial controls, that a safety constraint associated with the machine and the object is satisfied; and
determining, based at least on the safety constraint being satisfied, to use the one or more initial controls as the one or more controls.

7. The method of claim 1, wherein the one or more controls associated with the machine comprise one or more of:
a control corresponding to a velocity associated with the machine;
a control corresponding to an acceleration associated with the machine;
a control corresponding to a direction of travel associated with the machine; or
a control corresponding to a turning rate associated with the machine.

8. The method of claim 1, further comprising:
determining, using the one or more neural networks and based at least on second sensor data generated using the one or more sensors of the machine, a second output indicating a second level of responsibility of the one or more levels of responsibility, the second level of responsibility allocating responsibility between the machine and a second object in the environment,
wherein the determining the one or more controls associated with navigating the machine is further based at least on the second output.

9. The method of claim 1, further comprising:
obtaining training data representing:
one or more scenes of one or more environments that include one or more vehicles and one or more objects; and
one or more first parameters associated with the one or more vehicles and one or more second parameters associated with the one or more objects;
determining, using the one or more neural networks and based at least on the training data, one or more outputs indicating one or more levels of responsibility associated with the one or more vehicles and the one or more objects; and
updating, based at least on the one or more outputs and ground truth data representing one or more estimated levels of responsibility associated with the one or more vehicles and the one or more objects, one or more parameters associated with the one or more neural networks.

10. The method of claim 9, further comprising determining the one or more estimated levels of responsibility based at least on at least a portion of the training data and a control barrier function (CBF).

11. A system comprising:
one or more processing units to:
determine, using one or more neural networks and based at least on data corresponding to a scene of an environment that includes a first actor and a second actor, an output indicating one or more levels of responsibility allocated between the first actor and the second actor;
determine, based at least on the output, one or more controls associated with navigating the first actor; and
cause the first actor to navigate based at least on the one or more controls.

12. The system of claim 11, wherein the one or more processing units are further to:
obtain parameter data representing at least one of one or more first parameters associated with the first actor or one or more second parameters associated with the second actor,
wherein the output is further determined based at least on the parameter data.

13. The system of claim 11, wherein the scene is represented from a top-down perspective indicating one or more of:
a first position of the vehicle within the environment;
a second position of the object within the environment;
one or more driving surfaces within the environment; or
one or more traffic signs within the environment.

14. The system of claim 11, wherein the output comprises one of:
a first output indicating that the first actor has a greater level of responsibility than the second actor;
a second output indicating that the first actor has a same level of responsibility as the second actor; or
a third output indicating that the first actor has a lower level of responsibility than the second actor.

15. The system of claim 11, wherein the one or more controls are determined, at least, by:
determining one or more initial controls associated with navigating the first actor;
determining, based at least on the output and the one or more initial controls, whether a safety constraint associated with the first actor and the second actor is satisfied; and
one of:
updating, based at least on the safety constraint not being satisfied, the one or more initial control to include the one or more controls; or
determining, based at least on the safety constraint being satisfied, to use the one or more initial control as the one or more controls.

16. The system of claim 11, wherein the one or more processing units are further to:
determine, using the one or more neural networks and based at least on second data representing a second scene of a second environment that includes the first actor and a third actor, a second output indicating one or more second levels of responsibility allocated between the first actor and the third actor,
wherein the one or more controls are further determined based at least on the second output.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting one or more of augmented reality content, virtual reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to determine one or more controls associated with a machine based at least on an output indicating a level of responsibility allocated between the machine and an object, the output being determined using one or more neural networks and based at least on sensor data generated using one or more sensors of the machine.

19. The processor of claim 18, wherein the output is further determined based at least on data representing a scene of an environment that includes the machine and the object.

20. The processor of claim 18, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting one or more of augmented reality content, virtual reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
